(19) United States
(12) Patent Application Publication
(10) Pub. No.: US 2002/0124874 A1
(43) Pub. Date: Sep. 12, 2002

(54) Inside out gas turbine compressor cleaning method

(76) Inventor: John Jeffrey Butler, Oneida, NY (US)

Correspondence Address: HANCOCK & ESTABROOK, LLP, 1500 MONY Tower I, PO Box 4976, Syracuse, NY, 13221-4976, US

(21) Appl. No.: 10/141,672

(22) Filed: May 7, 2002

Related U.S. Application Data
(63) Continuation of application No. 09/606,789, filed on Jun. 28, 2000, now Pat. No. 6,394,108.
(60) Provisional application No. 60/141,426, filed on Jun. 29, 1999.

(51) Int. Cl. B08B 9/00

(52) U.S. Cl. 134/22.18; 134/34; 134/167 R; 134/172

(57) ABSTRACT

The inside out gas turbine cleaning method is a new method to clean axial gas turbine compressors. This is done by inserting a specially and fabricated flexible hose with nozzles on it into the first several stages of an off line gas turbine compressor. High pressure hot water with detergent is supplied to the hose and as it is withdrawn from the compressor it blasts dirt from the airfoil surfaces in the compressor. Conventional cleaning sprays water in one direction down the throat of the gas turbine compressor, whereas the this method cleans form the back forward giving a different blast angle with higher pressure water (see FIG. 1). Using both the conventional cleaning method and this new process, the compressor can be cleaned better allowing for improved gas turbine power and fuel efficiency.

### CROSS REFERENCE TO RELATED APPLICATION

The present application is a continuation of my U.S. patent application, Ser. No. 09/606,789, filed Jun. 28, 2000, now allowed.

### BACKGROUND OF THE INVENTION

The present invention related to systems and methods for cleaning turbine compressors. Applicant developed the idea for the inside out compressor cleaning after observation of fouled gas turbine compressors and information he learned while researching for a technical paper he published pertaining to the effect of rough airfoils in the turbine section of a gas turbine. Applicant's research revealed that rough surfaces affected gas trubine performance most when this roughness was located on the low pressure (suction or convex) surfaces of the airfoils (blading), especially nearer to the trailing edge. Applicant examined operational gas turbine compressors and noticed more dirt build up and roughness on the low pressure side of the airfoils, more toward the trailing edges. Further research revealed that roughness in this area is critical to all airfoils—not just the turbine airfoils presented in my research paper. It is in this diverging part of the airflow where the flow can change from laminar to turbulent very easily (due to a rough surface). See FIG. 2. Turbulent flow is a main contributor to friction drag and subsequent loss of airfoil performance.

Applicant examined gas turbine compressor rotor and to study the flow of water and detergent droplets as they would flow through the compressors during conventional washing operations. Applicant discovered that the heavier mass droplets would impact little on the low pressure (diverging or convex) sides of the airfoils. This is because much like a centrifugal separator, the droplets don't make flow direction changes as readily as a gas (in this case, air).

They do not fill into diverging or expanding areas, thus providing critical impact or “push” needed for cleaning action. Applicant realized at this point that one of the most critical surfaces on the airfoil was being neglected by conventional cleaning methods. Applicant determined that if cleaning from the back forward (inside out), we could get the low pressure surface cleaner (less rough). Looking down the throat of a compressor or if it is not apparent that someone could insert a host past several stages of blading. The blading looks too staggered to penetrate with a hose. Additionally, if a hose stuck in the compressor, the compressor rotor may have to be removed in order to get the hose out; a costly operation. But with a specially designed and constructed hose/nozzle assembly one can patiently insert (snake) the hose 7 or 8 stages (14 to 16 rows of blading or airfoils) into the compressor.

### BRIEF SUMMARY OF THE INVENTION

The inside out gas turbine cleaning method is a new system and method to clean axial gas turbine compressors. The is done by inserting a specially and fabricated hose with nozzles on it into the first several stages of an off line gas turbine compressor. High pressure hot water with detergent is supplied to the hose and as it is withdrawn from the compressor it blasts dirt form the airfoil surfaces in the compressor. Conventional cleaning sprays water in one direction down the throat of the gas turbine compressor, whereas this method cleans from the back forward giving a different blast angle with higher pressure water (see FIG. 1) Using both the conventional cleaning method and this new process, the compressor can be cleaned better allowing the improved gas turbine power and fuel efficiency.

### BRIEF DESCRIPTION OF DRAWINGS

FIG. 1 shows insertion of hose/nozzle assembly into first two stages of compressor.

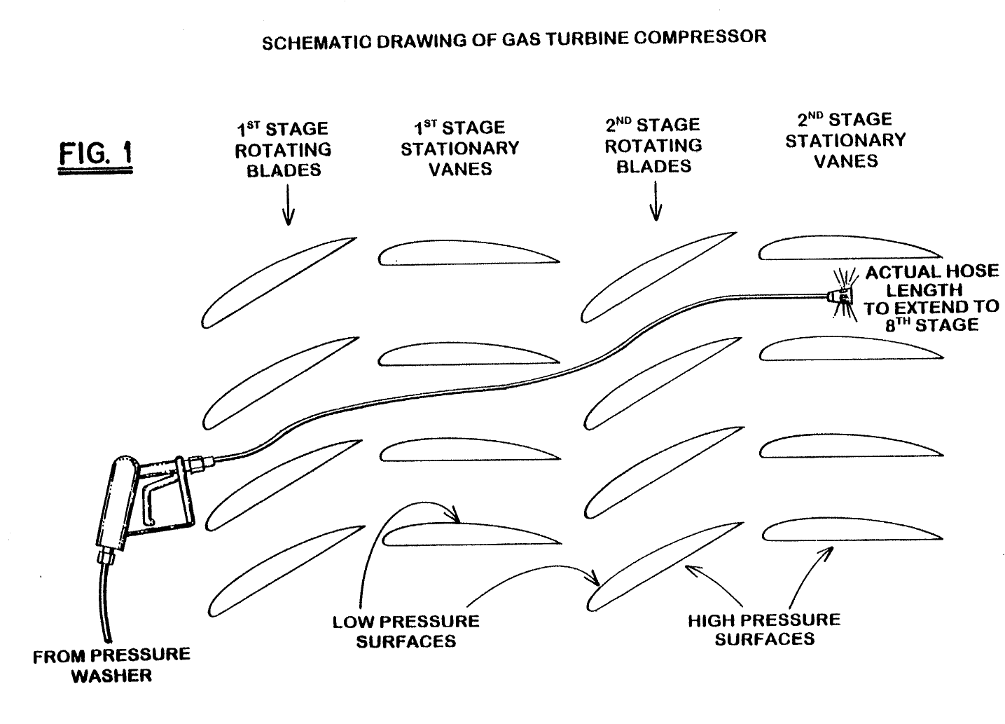

FIG. 2 shows turbulent flow on the low pressure side of an airfoil.

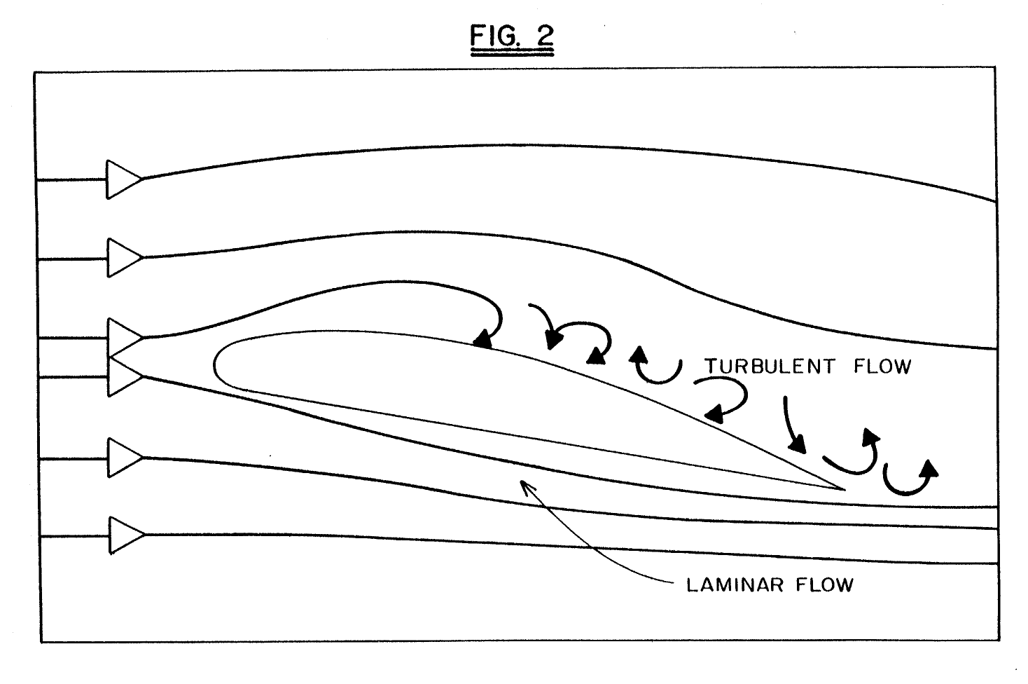

### DETAILED DESCRIPTION OF THE INVENTION

Inside out gas turbine cleaning method is a new method to clean axial gas turbine compressors when said compressor is not operating (off line) and not turning. This is done by inserting a specially designed and constructed flexible hose with radial nozzles in the tip into the first several stages of an off line gas turbine compressor. The smooth hose must be “snaked” past several stages (rows of blading and vanes). Due to size and space limitations, the inside out gas turbine cleaning method can only be utilized on larger axial compressors. Once the hose/nozzle assembly if fully inserted (typically 8 stages) a hand operated valve is opened and high pressure hot water form an industrial pressure washer (with our without detergent) blasts out of the radial nozzles in the tip of the hose. As hot water blasts out of the nozzles the hose/nozzle assembly is then slowly withdrawn past the 8 stages of blades and vanes. Dirt is blasted from the airfoil surfaces, including the low pressure, convex or “back” sides of the blades and vanes. Once the hand operated valve is closed and water stops flowing, the hose/nozzle assembly is next inserted between the next pair of vanes and snaked the approximate distance of 8 stages. This is repeated around the entire periphery of the compressor inlet. This is a time consuming process but performance gains have been significant.

Conventional cleaning sprays water in one direction down the throat of the axial gas turbine compressor, whereas this method cleans from the back forward (inside out) giving a different blast angle with high pressure water. Using both the conventional cleaning method and this new method, the compressor can be cleaned better allowing for improved gas turbine power and fuel efficiency.

The hose is a smooth, flexible, polymer stainless steel braided, abrasion resistant, high performance type. It has a custom designed and manufactured tip with several radial nozzles drilled into it. The hose and tip must be specially designed to not snag, get stuck or come apart inside the compressor. Since pressure washers supply hot water at very high pressures, host must have extremely high burst resistance. Additionally, this burst resistance must be many times higher than the pressure washer discharge pressure because of the on-off nature of the pressure washing trigger and dead end nature of the top. A fine mesh stainless steel strainer must precede the host to prevent the very small nozzle holes from plugging, “dead-heading” and increasing the chance of the tip popping off. Since demineralized water is generally used for cleaning and is aggressive at high pressures and flows, the hose must be made of special materials to resist corrosion/erosion. Demineralized water flowing at high velocity is known to generate high levels of destructive static electricity in a (polymer) non-conductive hose. Carbon is added to the polymer during the manufacture of the hose to make it conductive, reducing static buildup, thus reducing the chance of hose breakdown and failure.

What is claimed is:

1. A system for cleaning a gas turbine compressor while at rest, comprising:
a. a high pressure cleaning agent delivery apparatus;
b. a hose connected in fluid communication with said high pressure cleaning agent delivery apparatus; and
c. a cleaning agent distributing tip interconnected to said hose and adapted for insertion into said compressor, said cleaning agent distributing tip comprising a plurality of nozzles positioned radially there around.

2. The system of claim 1, wherein said hose is flexible.

3. The system of claim 2, wherein said hose includes a TEFLON® coating.

4. The system of claim 1, wherein said hose is partially composed of carbon.

5. The system of claim 1, further comprising a strainer positioned between said hose and said cleaning agent distributing tip.

6. A method for cleaning a gas turbine compressor while at rest, comprising the steps of:
a. inserting a hose that is connected to a high pressure cleaning agent delivery apparatus into said compressor;
b. actuating said high pressure cleaning agent delivery apparatus, whereby cleaning agent flows through said hose at high pressure; and
c. providing a tip interconnected to said hose that includes a plurality of nozzles extending radially therearound, whereby said cleaning agent is discharged from said hose and through said nozzles in a radial pattern relative to said compressor.

7. The method according to claim 6, further comprising the step of withdrawing said hose from said compressor while it is radially discharging said cleaning agent in said compressor.
